(19) United States
(12) Patent Application Publication
(10) Pub. No.: US 2014/0192256 A1
(43) Pub. Date: Jul. 10, 2014

(54) ELECTRO-OPTIC APERTURE DEVICE

(71) Applicant: Apple Inc., Cupertino, CA (US)

(72) Inventors: Jeffrey Nathan Gleason, San Francisco, CA (US); Henry H. Yang, Los Gatos, CA (US)

(73) Assignee: Apple Inc., Cupertino, CA (US)

(21) Appl. No.: 14/146,521

(22) Filed: Jan. 2, 2014

Related U.S. Application Data
(60) Provisional application No. 61/748,988, filed on Jan. 4, 2013.

(51) Int. Cl. H04N 5/225; G02F 1/153

(52) U.S. Cl. CPC H04N 5/2257; G02F 1/153
USPC 348/362; 348/376

(57) ABSTRACT

A portable consumer electronics device has a handheld portable device housing, and an electronic camera module integrated in the housing. The module has a focusing lens to focus light from a scene, an imaging sensor to receive the focused light, and an electro-optic variable aperture to allow different amounts of the light from the scene to reach the imaging sensor. The aperture has a stack that includes a front transparent conductor medium, an electrolyte medium, an active electro-chromic medium, and a rear transparent conductor medium. Other embodiments are also described and claimed.

### RELATED MATTERS

This non-provisional application claims the benefit of the earlier filing date of provisional application No. 61/748,988 filed Jan. 4, 2013.

An embodiment of the invention relates to a variable solid-state aperture for a camera that may be integrated within a portable consumer electronics device. Other embodiments are also described.

### BACKGROUND

Camera modules have been incorporated in a variety of consumer electronics devices, such as smart phones, mobile audio players, personal digital assistants, laptop and tablet computers, as well as desktop personal computers. A typical digital camera module is an assembly in which at least the following components have been integrated: a microelectronic imaging sensor integrated circuit chip, a printed circuit carrier such as a flexible circuit structure which carries power and signal connections between the sensor chip and other circuitry inside the consumer electronics device, and an optical system which includes a fixed focal length lens subsystem or autofocus lens subsystem. There may be additional optical elements such as infrared filters and neutral density filters. Typically, in most consumer electronics portable devices such as smart phones and tablet computers, which have a relatively thin profile (or a so-called shallow z-height), the various optical path apertures in the optical system are of the fixed variety. That is in part because conventional variable apertures that use leaflets for example are not only complex (adding to the cost of the device as a whole) and more susceptible to physical shock or damage, but they also require additional headroom in the z-height direction, thereby leading to a thicker smartphone or tablet computer.

There has been a suggestion to use an electro-optic aperture in an imaging system, in order to avoid the use of moving parts while at the same time achieving improved focusing and greater depth of field. The electro-optic aperture may include an electro-chromic (EC) medium that attenuates light from the scene that is passing through the aperture, in response to a voltage being applied to a pair of transparent conductor layers between which the EC medium is sandwiched. An abrupt void or gap is formed in one of the transparent conductor layers, so as to form a ring-like aperture whose inner area remains transparent when the EC medium is energized and whose outer area becomes dark, thereby yielding in effect a smaller pupil. The electro-optic aperture may be positioned between a focusing lens of the system and the scene being imaged.

### SUMMARY

An embodiment of the invention is a portable consumer electronics device having a hand held portable device housing, and an electronic camera module that is integrated in the housing. The module has a focusing lens to focus light from a scene, and an imaging sensor to receive the focused light. An electro-optic variable aperture is provided to allow different amounts of light from the scene to reach the imaging sensor (through the focusing lens). The aperture has a stack that includes a front transparent conductor medium, an electrolyte medium, an active EC medium, and a rear transparent conductor medium. A driver circuit that can produce a variable voltage is coupled to the transparent conductors, so as to apply the variable voltage to thereby change the active EC medium between dark and clear states, as desired. In one embodiment, the voltage may be continuously varied to achieve a continuously variable desired darkness or color level in the EC medium, or it may be varied across discrete levels. In one instance, applying a greater activation voltage yields in effect a smaller pupil, that is, a greater f-number. In that case, the aperture is passing less light so that a darker optical image is projected onto the image sensor. Conversely, if the driver produces a smaller activation voltage, then the EC medium becomes less dark and/or has less color effectively yielding a larger or wider pupil; this allows increased light from the scene to reach the imaging sensor. The process is reversible in that the driver can also produce a voltage that returns the EC medium to its clear state. Such a variable aperture allows for flexible fine-tuning of the final exposure at which a picture of the scene is captured.

In one embodiment, the EC medium has a layer of active EC material that is oriented substantially perpendicular to an optical axis of the camera module but that has a tapered thickness. In particular, the layer of active EC material may be substantially ring-like or annular in that the tapered thickness drops to essentially zero in an inner region of the layer, where this inner region may be substantially centered or aligned with the optical axis.

In another embodiment, the front transparent conductor medium is a patterned layer, so that a ring-like electric charge flow is generated through the EC medium when the activation voltage is applied to the conductor mediums (to thereby achieve in effect a smaller pupil). The patterned layer may have a gap or hole formed therein that may be substantially centered or aligned with the optical axis. This gap may be filled with an optical material different than the transparent conductor material and that has a desired index of refraction, or it may be simply left as an open space full of air.

In yet another embodiment, an inner plug region is formed in the front transparent conductor medium, where the plug region is of the same material as, but is electrically isolated from, an outer region of the transparent conductor medium. This technique may also yield a ring-like charge field through the EC medium (when the activation voltage is applied to the outer region of the front transparent conductor medium and the rear conductor medium in order to effectively produce a smaller pupil).

In yet another embodiment, the electrolyte medium has an ion source medium (positioned adjacent to the front conductor) that is in contact with an ion conduction medium (which is adjacent to the EC medium). The ion conduction medium in this embodiment is a patterned layer so that once again a ring-like charge filed is generated through the EC medium, when the activation voltage is applied to the transparent conductor mediums. In particular, a hole may be formed within an inner region of the layer of ion conduction medium, such that insubstantial electrical current is generated through the EC medium that lies directly underneath the hole thereby allowing that portion of the EC medium to remain clear even when the activation voltage is being applied.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 depicts a portable consumer electronics device in which a camera module having an E-O variable aperture is integrated.

FIG. 2 is a block diagram of camera-related elements including a camera module and associated electronics circuitry.

FIG. 3 is a cutaway view of an E-O variable aperture in accordance with an embodiment of the invention.

FIG. 4 is a cutaway view of an E-O variable aperture in accordance with another embodiment.

FIG. 5 is a cutaway view of yet another embodiment.

FIG. 6 is a cutaway view of a further embodiment of the E-O variable aperture.

### DETAILED DESCRIPTION

Several embodiments of the invention with reference to the appended drawings are now explained. Whenever the shapes, relative positions and other aspects of the parts described in the embodiments are not clearly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

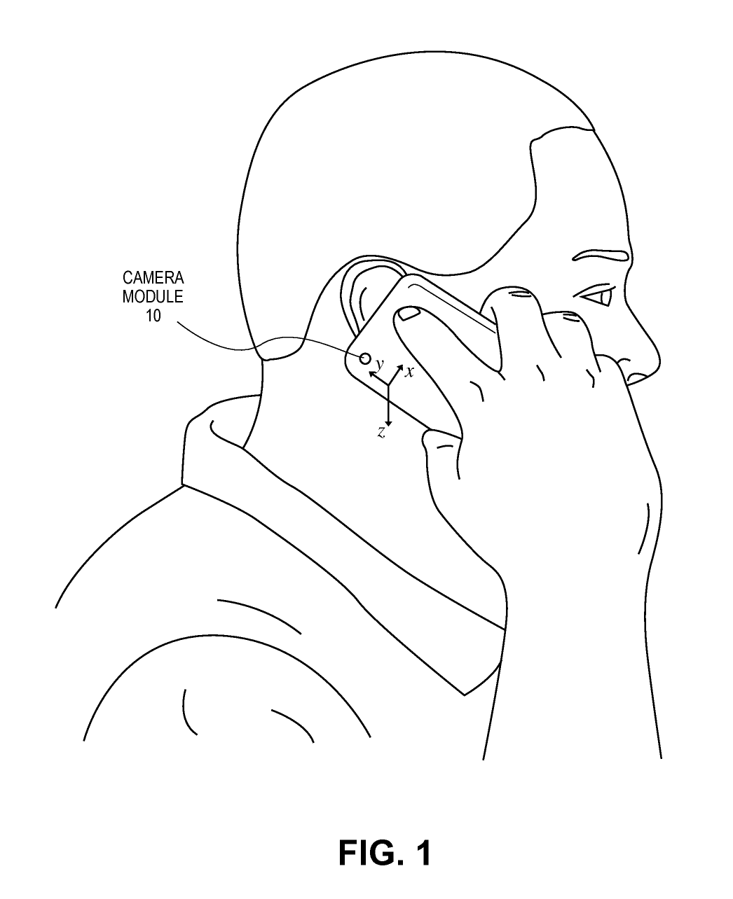

FIG. 1 depicts an example portable consumer electronics device in use by the end user, and in which a camera module 10 is integrated. In this example, the device is a smart phone having a front face that is up against an ear of the user during a phone call that is being conducted. The rear face has an opening through which the camera module 10 is visible. The camera module 10 may alternatively be integrated within other portable consumer electronics devices such as tablet computers and laptop or notebook computers. The camera module 10 could also be integrated in non-portable consumer electronics devices and in particular those where the so-called thickness or z-height or depth of the external housing is limited, making it difficult to use a mechanically variable aperture. An embodiment of the invention is an electro-optically (E-O) variable aperture that is particularly suitable for use in the tight confines of such devices.

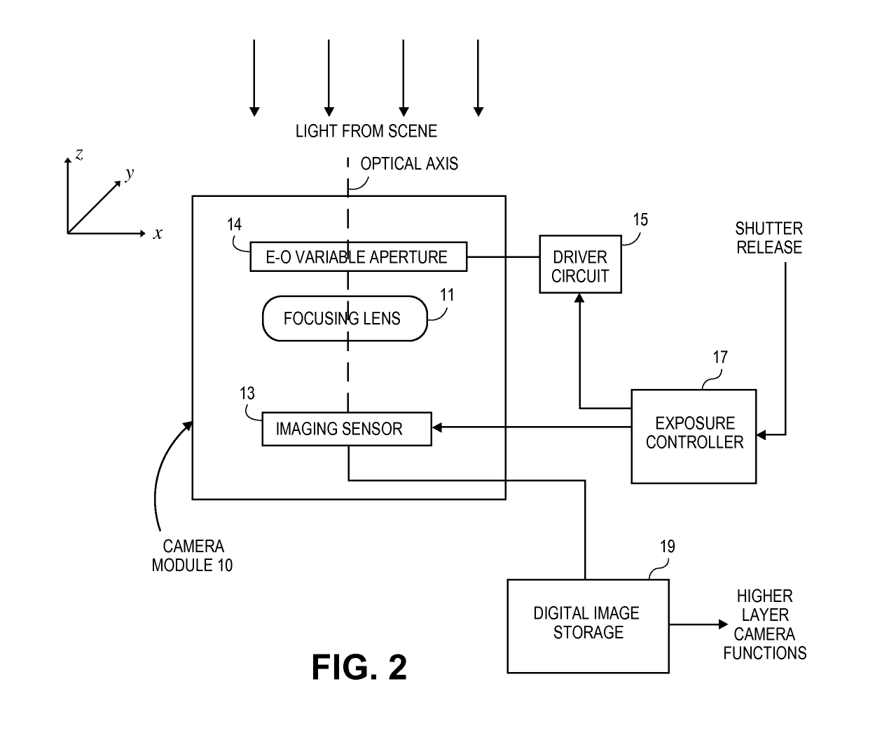

FIG. 2 is a block diagram of the camera module 10 together with electronic circuit elements that are needed to implement the camera function. Note that there may be additional functions that are implemented in the consumer electronics device as is known to those of ordinary skill in the art but that are not described here in the interest of conciseness, e.g. communication network interfaces, display screens, touch screens, keyboards, and audio transducers. The camera module 10 has an imaging sensor 13 that is part of an optical system, which also includes a focusing lens 11 and an E-O variable aperture 14. These optical elements are aligned to an optical axis as shown. Note however, that while in this particular example all of the optical elements are in a straight line, in other embodiments there may be a mirror or other optical deflector that allows one or more of the elements to be positioned off of a straight line. Nevertheless, those elements may still be considered “aligned with the optical axis.” What is shown in FIG. 2 is a particularly efficient mechanism (in terms of packaging) that can fit within the tight confines of a low z-height device such as a smart phone, a tablet computer, or a laptop computer, where, in particular, all of the optical interfaces are positioned substantially parallel to a front or rear face of the external housing of the device. In other words, each optical element lies flat within an x-y plane with its height given in the z-direction shown.

The imaging sensor 13 may be any conventional solid-state imaging sensor such as a complimentary metal oxide semi conductor (CMOS) sensor chip, which presents an interface to an exposure controller 17 to receive certain parameters for determining an exposure for taking a picture. The sensor parameters may include pixel integration time, which may be set by the exposure controller 17 in accordance with any suitable exposure control algorithm that considers various input variables (e.g., level of scene illumination and the availability of a flash or strobe illumination). The exposure controller 17 may automatically perform the algorithm to determine an appropriate exposure setting, and then signal the imaging sensor to update its parameters in response to a manual shutter release command (e.g., in response to a mechanical or virtual shutter button being fully actuated by a user of the device). The exposure controller 17 may be implemented as a programmed processor or as a completely hardwired logic state machine together with stored parameter options. Once a digital image has been captured by the imaging sensor 13 under the chosen exposure setting, it may be transferred to a digital image storage 19 (e.g., solid state volatile or non volatile memory), prior to being further processed or analyzed by higher layer camera functions that yield for example a still picture file (e.g., in a JPEG format) or a video file (e.g., in a digital movie format).

Also included in the camera module 10 is a focusing lens 11 which may include one or more lens elements that serve to focus light from the scene onto the imaging sensor 13 (thereby producing an optical image on an active pixel array portion of the imaging sensor 13). The focusing lens 11 may include either a fixed focus optical subsystem, or a variable focus subsystem that implements an autofocus mechanism. There may also be an optical zoom mechanism, as part of the focusing lens 11. In the case of an optical zoom lens and/or an auto focus mechanism, additional control parameters relating to lens position can be set by the exposure controller 17 for each exposure to be taken, as is apparent to those of ordinary skill in the art.

The camera module 10 also has the E-O variable aperture 14, which for the sake of simplicity is shown as being positioned in front of the focusing lens 11. The aperture 14 effectively implements a pupil whose width or size is electrically variable. The aperture 14 may be positioned at any suitable aperture location along the optical axis in front of the imaging sensor 13. When the aperture 14 has been electrically controlled into a small or narrow pupil, highly collimated rays are admitted by it, which results in a sharp focus at an image plane of the optical system. On the other hand, when the aperture 14 is configured into a large or wide pupil, un-collimated rays are admitted resulting in an optical image that is sharp around what the focusing lens 11 is focusing on, and may be blurred otherwise. The aperture 14 thus determines how collimated the admitted rays of light from the scene are, that ultimately come to a focus in an image plane. The aperture 14 also determines the amount of incident light or how many incoming rays are admitted, and thus how much light reaches the imaging sensor, where of course the narrower the aperture the darker the digital image that is captured by the sensor 13 (for a given integration time). Control of the effective pupil size of the aperture 14 is achieved using an electronic driver circuit 15, which may receive a control signal or command from the exposure controller 17 that may represent the desired size of the effective pupil. The driver circuit 15 translates this input command into a drive voltage that is applied to the input transparent conductors of the aperture 14, as described below.

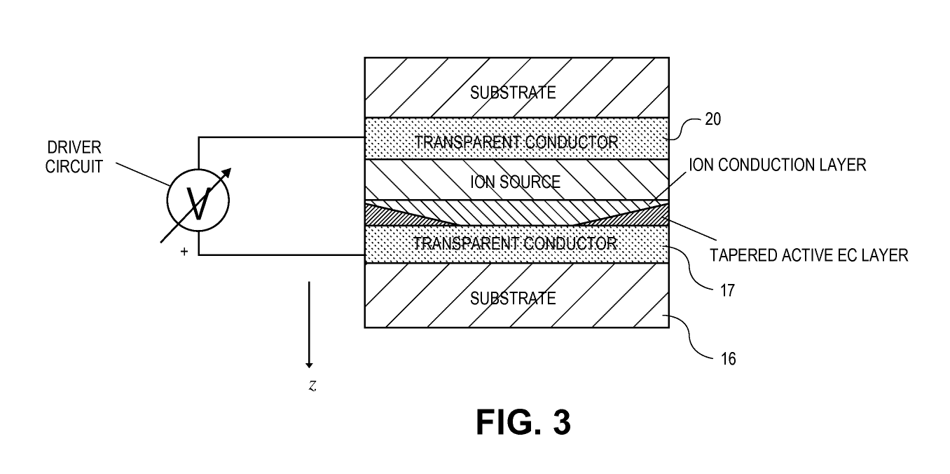

Turning now to FIG. 3, a cutaway view of the aperture 14 in accordance with an embodiment of the invention is shown. As can be seen, the aperture 14 has a stack that includes a front transparent conductor medium 17 which in this example is connected to the “+” terminal of the driver circuit, an electrolyte medium, an active EC medium, and a rear transparent conductor medium 20 (connected to the complimentary terminal of the driver circuit). In one embodiment, the elements of the stack are formed to be in contact with one another as they are depicted in the figure, i.e., the electrolyte medium is formed as a layer whose surface is in contact with the rear transparent conductor medium or layer 20, and whose opposite surface is in contact with an active EC layer, while a lower surface of the latter is in contact with the front transparent conductor layer 17.

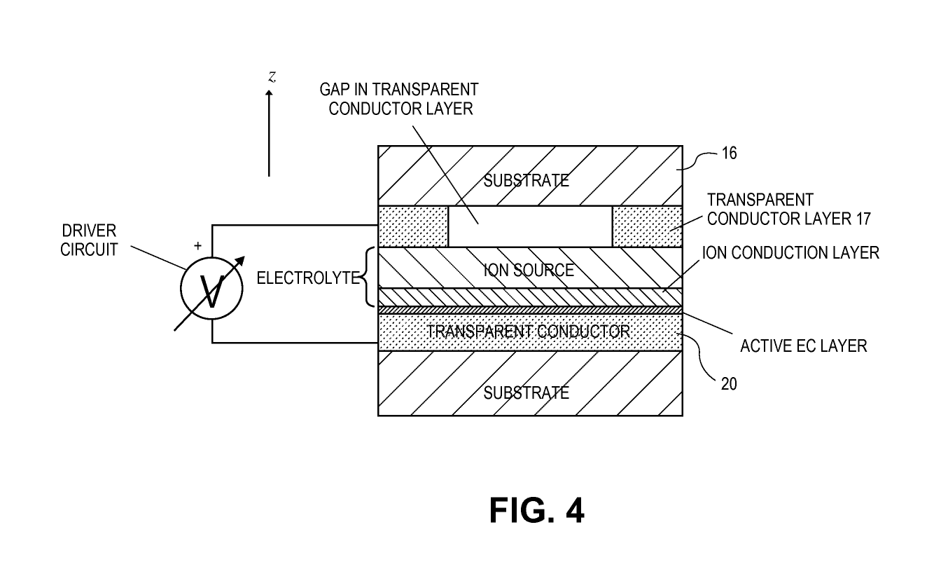

In one embodiment, the electrolyte medium consists of an ion source medium that is adjacent to the rear transparent conductor 20 and is in contact with an ion conduction medium or layer, which in turn is adjacent to the active EC layer. Here, an ion source layer is formed that is not in contact with the active EC layer, but rather is in contact with the ion conduction layer, the latter being in contact with the active EC layer. In other words, the ion conduction layer is entirely sandwiched between the ion source layer and the active EC layer. This arrangement may also be found in other embodiments of the aperture 14, for instance as they are depicted in the cut away views of FIGS. 4-6.

The ion source layer stores suitable ions, for example, lithium ions, that will be used for activating the EC layer when a sufficient charge field, that may be generally vertically directed in the context of the figures here, has been generated between the transparent conductor layers 17, 20. In addition, the ion source layer should be sufficiently clear or transparent to allow light rays from the scene to pass through (in a generally vertical direction in the context of the figures here).

The ion conduction layer allows for high mobility of the ions that have been produced by the ion source when entering the active EC layer.

The transparent conductor layers 17, 20 in the front and rear may be formed on the respective surfaces of a front substrate and a rear substrate. The transparent conductor may be, for example, a layer of indium tin oxide (ITO) or other transparent conductive material that is formed as a relatively thin layer. The transparent conductor provides a conductive path for charge from the driver circuit to be applied to the ion source while at the same time allowing the free passage of light rays from the scene. In this case, the front transparent conductor 17 is formed on a rear face of a front substrate 16, while the rear transparent conductor 20 is formed on a front face of a rear substrate. Not that the references here to “front” and “rear” are only to make it easier to describe the structure of the aperture 14 and are not intended to be otherwise limiting. For example, in one embodiment, the incident light enters through the front substrate 16 that is at the top of the stack shown in FIG. 3; the aperture 14 may also work where the incident light from the scene enters the aperture through the rear substrate. Note that either or both of the substrates may be made of glass, polycarbonate, or other suitable material or composition that is transparent enough for use in an optical system of a consumer electronics camera and that can be used to support the formation of the transparent conductor layers.

Still referring to FIG. 3, in this embodiment, the active EC layer is tapered as shown, forming a gradual (rather than abrupt) ring as viewed from above (not shown). In other words, while the EC layer spreads substantially perpendicular to an optical axis of the camera module 10 (see FIG. 2) it does not have uniform thickness and instead has a tapered thickness that drops to essentially zero within an empty inner region of the EC layer as shown in FIG. 3. In this case, this empty inner region is substantially aligned with or centered with the optical axis. The downward tapering of the EC layer makes way for the material of the ion conduction layer to fill that gap, resulting in a substantially frusto-conical shape for the ion conduction layer as seen in FIG. 3. The tapered active EC layer thus presents a minimum pupil width for the aperture 14, being in this case co-extensive with the bottom of the tapered active EC layer.

In operation, the aperture 14 presents effectively a wide pupil so long as there is insufficient current through the outer region of the EC medium, which can be achieved when essentially zero voltage is being applied by the driver circuit to the front and rear transparent conductors. When the driver increases the voltage, ions are forced to travel from the electrolyte medium through the tapered active EC layer, which darkens that outer region of the EC layer. Here it should be noted that the darkness of the EC layer depends on the thickness at that point, in addition to the strength of the current at that point. Thus, the darkness change in the tapered EC layer is gradual in that the darkness increases as one moves outward, away from the center optical axis, for a given fixed voltage. This may help create a sharper image on the imaging sensor 13 (see FIG. 2) than an E-O aperture that has a well-defined or abrupt edge within the active EC layer.

Although not shown in the drawings, a top view of the aperture 14 reveals that the inner region which may be centrally aligned with the optical axis may be formed into any suitable shape, although it is expected that a circular shape may produce improved results in that it matches the naturally circular shape of a lens element of the focusing lens 11. Also, while there are several references here to a “ring” or “ring-like” shape, this does not mean that the external boundary of that shape is necessarily also circular, but rather that the shape is merely annular in that there is an essentially empty inner region surrounded by a non-empty outer region.

The overall process of activation and deactivation of the EC layer is reversible, so that the outer region of the active EC layer can transition from a substantially clear (transparent) state into a colored or dark state in response to sufficient current being produced through it, and back when the activation voltage is removed.

In one embodiment, in its clear state (e.g., zero drive voltage), the aperture 14 has at least 95 percent transmission of light in a visible band of interest (for consumer electronics digital photography); when the effective pupil diameter is then decreased by three “aperture stop” steps (where each step reduces the diameter by a factor of square root of 2, or about 1.414, hence a halving of the effective area of the pupil), the aperture 14 should still exhibit at least 75 percent light transmission.

Turning now to FIG. 4, a cut away view of another embodiment of the invention is shown, where in this case the aperture stack is formed such that its front transparent conductor medium or layer 17 is a patterned layer. In particular, as shown in FIG. 4, the front transparent conductor layer 17 has a gap or hole formed in it (e.g., through chemical or mechanical etching) that is substantially aligned with or centered with the optical axis. This gap results in insufficient current being generated through the portion of the active EC layer that lies directly under the gap, to activate that portion of the EC medium. In other words, a ring-like current is generated through the active EC layer (when the activation voltage is applied by the driver circuit). This ensures that the inner region of the aperture stack remains essentially clear, forming a minimum effective pupil width, substantially coextensive with the gap in the transparent conductor layer 17, at a high activation voltage, and yields a progressively larger pupil width as the activation voltage is reduced. In this embodiment, the EC medium consists of an active EC layer that is substantially perpendicular to the optical axis but that also has essentially uniform thickness as shown. The voltage applied by the driver circuit may be modulated or changed continuously from a low or minimum level such as zero volts, which yields a low opacity in the outer region of the EC layer, to a high voltage that yields a high opacity in the outer region of the EC layer.

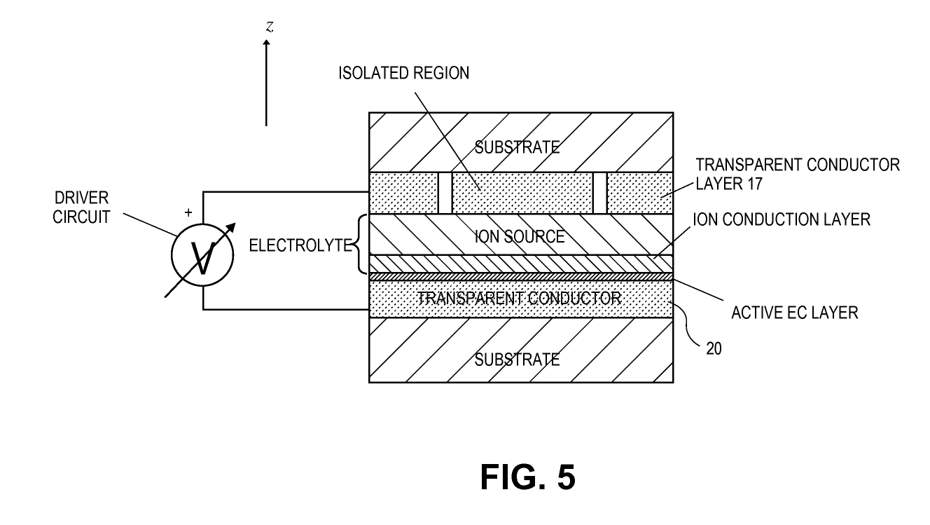

Referring now to FIG. 5, this cut away view illustrates an embodiment where the front transparent conductor medium 17 of the aperture stack contains an inner transparent conductor plug region, also referred to as an isolated region, i.e., electrically isolated from an outer region of the front transparent conductor medium 17. This isolated region may be essentially centered or aligned with the optical axis. It may remain electrically floating or it may alternatively be tied to a different voltage than the outer region of the front transparent conductor, while the latter is being driven to an activation voltage by the driver circuit. This mechanism again produces a ring-like current through an outer region of the active EC layer, thereby maintaining very low opacity in the inner region of the active EC layer. Thus, similar to the embodiments described above, at a high drive voltage, the outer region of the active EC layer (which is subjected to the ring-like current) reaches high opacity, while its inner region is subjected to essentially no or very low current and thus remains at low opacity.

It should be noted that a further advantage of the embodiment of FIG. 5 over that of FIG. 4 may be that the difference in optical property between the inner region of the optical path through the aperture 14 (centered or aligned with the optical axis), and the outer region of the optical path (which is subjected to greater opacity by the active EC layer) is reduced, when the drive voltage is minimum and the pupil size is at its widest. In other words, light rays from the scene that pass through the inner region of the aperture 14 will be subjected to essentially the same optical characteristics as the light rays that travel through the outer region (assuming that the effect of the physical gap shown between the isolated region and the outer region of the front transparent conductor layer 17 in FIG. 5 can be ignored). This may not be the case with the embodiment of FIG. 3 (because of the tapered active EC layer) and with the embodiment of FIG. 4 (because of the substantial gap in the transparent conductor layer 17).

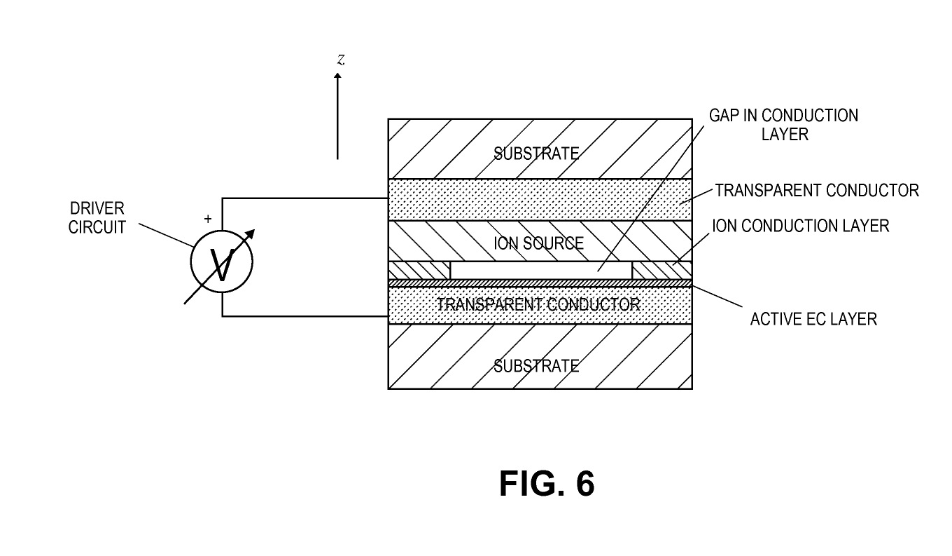

Turning now to FIG. 6, in yet another embodiment of the aperture stack, the ion conduction medium becomes a patterned layer as shown, by forming a gap or hole in what may be an otherwise uniformly thick ion conduction layer. The hole may be substantially aligned or centered with the optical axis as shown. This means that when the activation voltage is applied by the driver circuit, not enough ions from the ion source layer will be traveling through the (empty) inner region of the ion conduction layer, and thus should not impact the inner region of the active EC layer that lies directly underneath the hole. Thus, there should be no substantial darkening of the inner region of the active EC layer. Once again, a minimum effective pupil width is achieved in this case, using a different mechanism than those described in FIGS. 3-5. Once again, a ring-like current is generated through the EC layer (when the activation voltage is applied by the driver circuit) in order to reduce the width of the aperture. The minimum width or area of the aperture may correspond to essentially the size of the hole in the ion conduction layer.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. For example, while the figures show a particular order for the stack up of the various layers of the aperture 14, the positions of some of the layers can be changed while still achieving similar results. The description is thus to be regarded as illustrative instead of limiting.

What is claimed is:

1. A portable consumer electronics device comprising:
a handheld portable device housing; and
an electronic camera module integrated in the housing, the module having a focusing lens to focus light from a scene, an imaging sensor to receive the focused light, and an electro-optic variable aperture to allow different amounts of the light from the scene to reach the imaging sensor,
wherein the aperture has a stack that includes a front transparent conductor medium, an electrolyte medium, an active electro-chromic medium, and a rear transparent conductor medium.

2. The device of claim 1 wherein the electrolyte medium comprises an ion source medium adjacent to the front transparent conductor, and an ion conduction medium adjacent to the electro-chromic medium.

3. The device of claim 1 wherein the aperture stack further comprises a front substrate on which the front transparent conductive medium is formed.

4. The device of claim 3 wherein the aperture stack further comprises a rear substrate on which the rear transparent conductive medium is formed.

5. The device of claim 1 wherein the aperture is positioned so that the front transparent conductor is closer to the scene than the rear transparent conductor.

6. The device of claim 1 further comprising:
a driver circuit to produce a variable voltage and being coupled to the transparent electrodes of the aperture so as to apply the variable voltage, to activate the aperture;
an exposure controller to receive a user-triggered shutter release command and in response signal a) the driver circuit to apply a particular voltage to activate the aperture and b) the sensor to apply a particular integration time, in accordance with a given exposure setting; and
a digital image storage coupled to receive a captured digital image from the sensor.

7. The device of claim 1 wherein the handheld portable device housing has a side that joins a front face and a rear face of the housing, and wherein the camera module is oriented in the housing such that the focusing lens is substantially parallel with the rear face of the housing and receives light from the scene through an opening in the rear face of the housing.

8. The device of claim 1 wherein the electro-chromic medium comprises a layer of electro-chromic material that is substantially perpendicular to an optical axis of the camera module and that has essentially uniform thickness.

9. The device of claim 1 wherein the electro-chromic medium comprises a layer of electro-chromic material that is substantially perpendicular to an optical axis of the camera module but that has tapered thickness.

10. The device of claim 9 wherein the layer of electro-chromic material is substantially ring-like or annular in that the tapered thickness drops to essentially zero in an inner region of the layer.

11. The device of claim 1 wherein the front transparent conductor medium is a patterned layer so that a ring-like current is generated through the electro-chromic medium when an activation voltage is applied to the front and rear conductor mediums.

12. The device of claim 11 wherein a hole is formed within an inner region of the patterned layer of the front transparent conductor medium, such that essentially no sufficient current is generated through the portion of the electro-chromic medium that lies directly under the hole which would activate the electro-chromic medium.

13. The device of claim 11 wherein the electro-chromic medium comprises a layer of electro-chromic material that is substantially perpendicular to an optical axis of the camera module and that has essentially uniform thickness.

14. The device of claim 1 wherein the front transparent conductor medium contains an inner plug region that is substantially electrically isolated from an outer region, so that a ring-like current is generated through the electro-chromic medium when an activation voltage is applied to the outer region of the front conductor medium and the rear conductor medium.

15. The device of claim 14 wherein the electro-chromic medium comprises a layer of electro-chromic material that is substantially perpendicular to an optical axis of the camera module and that has essentially uniform thickness.

16. The device of claim 1 wherein the ion conduction medium is a patterned layer so that a ring-like current is generated through the electro-chromic medium when an activation voltage is applied to the front and rear conductor mediums.

17. The device of claim 16 wherein a hole is formed within an inner region of the patterned layer of the ion conduction medium, such that essentially no sufficient current is generated through the portion of the electro-chromic medium that lies directly under the hole which would activate the electro-chromic medium.

18. The device of claim 16 wherein the electro-chromic medium comprises a layer of electro-chromic material that is substantially perpendicular to an optical axis of the camera module and that has essentially uniform thickness.

19. The device of claim 1 wherein the ion source medium and the rear transparent conductor medium are uniform thickness layers.
